(19) United States
(12) Patent Application Publication
(10) Pub. No.: US 2011/0109114 A1
(43) Pub. Date: May 12, 2011

(54) SEAT FOR A VEHICLE

(75) Inventors: Kevin G. Kolpasky, Oakland Township, MI (US); Wayne Manista, Berkley, MI (US); Mark Louis Kaski, Royal Oak, MI (US)

(73) Assignee: GM GLOBAL TECHNOLOGY OPERATIONS, INC., Detroit, MI (US)

(21) Appl. No.: 12/614,528

(22) Filed: Nov. 9, 2009

(51) Int. Cl. B60N 2/02; B60N 2/14; B60N 2/46; A47C 31/00; A47C 7/68; A47C 7/70; A47C 7/72; B60N 2/44; B60N 2/20; A47C 7/46

(52) U.S. Cl. 296/65.13; 297/344.21; 297/115; 297/217.1; 297/135; 297/145; 297/146; 297/217.4; 297/354.13; 297/284.1

(57) ABSTRACT

A vehicle seat includes a lower seat cushion and a seatback. The vehicle seat includes a pivot point that is configured for rotating generally horizontally from an inboard position to an outboard position. An extended seat track may extend within an interior of the vehicle between a front row and a rear row. The vehicle seat is movably attached to the extended seat track and is configured to move along the extended seat track between the front row and the rear row. The vehicle seat may also be configured to provide individualized comfort to the user. The lower seat cushion and the seatback each include a surface. A controller is configured to actuate the lower seat and the seatback to selectively change a contour of the respective surface to match contours of the user.

### TECHNICAL FIELD

The present invention relates to a seat for a vehicle.

### BACKGROUND OF THE INVENTION

Automotive vehicles are becoming more customizable in order to meet the values and priorities of customers. Vehicle owners generally desire flexibility to reconfigure a vehicle to meet their specific needs. For example, customers appreciate the ability sit comfortably within the vehicle. Likewise, customers appreciate vehicle seats that are easy to get into and out of.

### SUMMARY OF THE INVENTION

A vehicle seat is configured for use within a front of a vehicle. The vehicle seat includes a lower seat cushion and a seatback. The lower seat cushion is configured for supporting a user of the vehicle. The seatback extends from the lower seat cushion and is configured for supporting a torso of the user of the vehicle. The lower seat cushion is pivotable about a pivot point which enables rotation of the lower seat cushion generally horizontally about the pivot point from an inboard position to an outboard position.

Another aspect of the invention includes a seat system for a vehicle defining an interior having a front row and a rear row behind the front row. The seat system includes an extended seat track and a front vehicle seat. The extended seat track extends within the interior of the vehicle between the front row and the rear row. The front vehicle seat is movably attached to the extended seat track. The front vehicle seat is configured to move along the extended seat track between the front row and the rear row.

In another aspect of the invention, a vehicle seat is configured to provide individualized comfort to a user of the vehicle. The vehicle seat includes a lower seat cushion, a seatback, and a controller. The lower seat cushion includes a surface configured for supporting the user of the vehicle. The seatback includes a surface configured for supporting a torso of the user. The seatback extends from the lower seat cushion. The controller is operatively connected to at least one of the lower seat and the seatback. The controller is configured for actuating the lower seat and/or the seatback to selectively change a contour of the surface of the corresponding lower seat cushion and/or seatback to match contours of the user.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

Referring now to the figures, which are exemplary embodiments and wherein like elements are numbered alike:

FIG. 1 is a schematic plan view of a vehicle having seat systems;

FIG. 2 is a schematic perspective side view of a front vehicle seat of the seat system of FIG. 1 mounted to a seat track;

FIG. 3 is a schematic perspective side view of another embodiment of the front vehicle seat of the seat system of FIG. 1 mounted to the seat track;

FIG. 4 is a schematic perspective side view of the seat system of FIG. 1 illustrating the front vehicle seat disposed in a rear row of the vehicle;

FIG. 5 is a schematic rear view of the front vehicle seats having tray tables; and

FIG. 6 is a schematic side view of one of the front vehicle seats disposed in a reclined position with a foot rest in an extended position.

### DESCRIPTION OF THE PREFERRED EMBODIMENTS

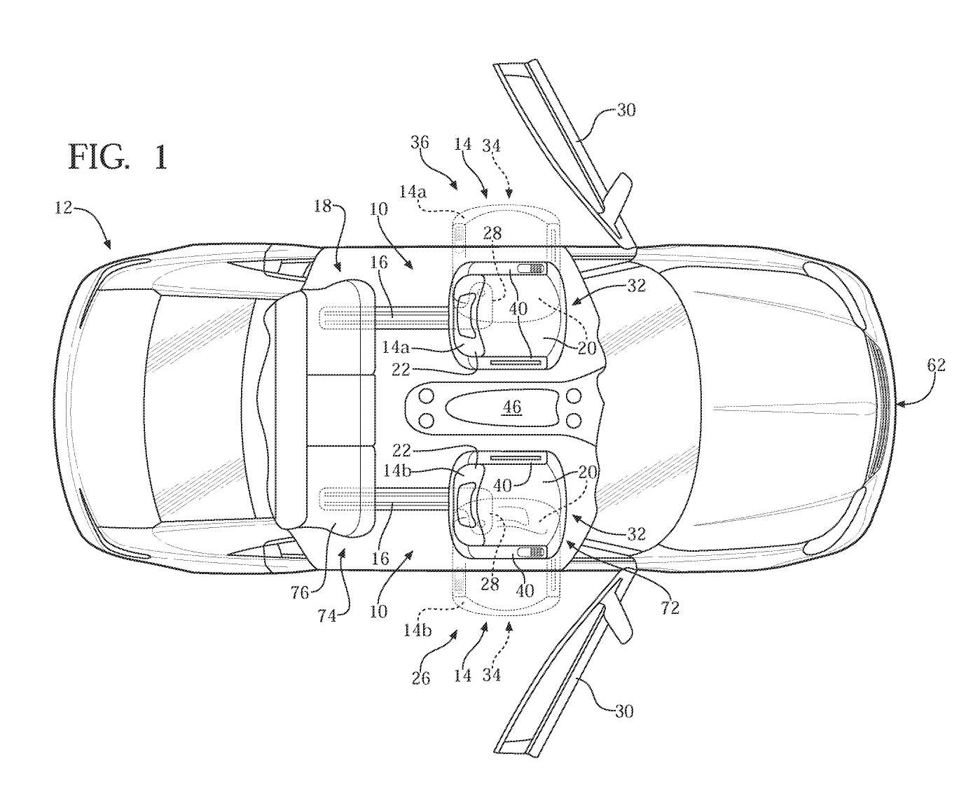

Referring to the drawings, wherein like reference numbers refer to like components, a seat system for a vehicle 12 is shown at 10 in FIG. 1. The seat system 10 includes a front vehicle seat 14 and a seat track 16 that are disposed within an interior 18 of the vehicle 12. The vehicle seat 14 may be a driver's seat 14a or a passenger's seat 14b. The vehicle seat 14 includes a lower seat cushion 20 and a seatback 22 extending from the lower seat cushion 20. The lower seat cushion 20 is configured for supporting the user 24 of the vehicle 12 and the seatback 22 is configured for supporting a torso of the user 24. The vehicle seat 14 is configured to provide high functionality and comfort to the user 24 seated thereon.

Referring again to FIG. 1, the vehicle seat 14 may be configured to aid in ingress and/or egress to and from the vehicle 12. More specifically, as illustrated at 26 in FIG. 1, the entire vehicle seat 14 may rotate outward, about a pivot point 28, to present the entire seat to an outside of the vehicle 12 when a corresponding vehicle door 30 is in an open position. This means that the vehicle seat 14 rotates horizontally, relative to the ground G, from an inboard position 32 to an outboard position 34. Alternatively, as illustrated at 36 in FIG. 1, only the lower seat cushion 20 rotates outward, about a pivot point 28, to present only the lower seat cushion 20 to the outside of the vehicle 12 when the corresponding vehicle door 30 is in the open position. The vehicle seat 14 and/or the lower seat cushion 20 may rotate about the pivot point 28 generally 90 degrees between positions. It should be appreciated that other angles of rotation may also be used, as known to those skilled in the art. The pivot point 28 may generally be at a rear, outboard position on the seat. However, it should be appreciated that the pivot point 28 may be at any other location on the vehicle seat 14, as known to those skilled in the art.

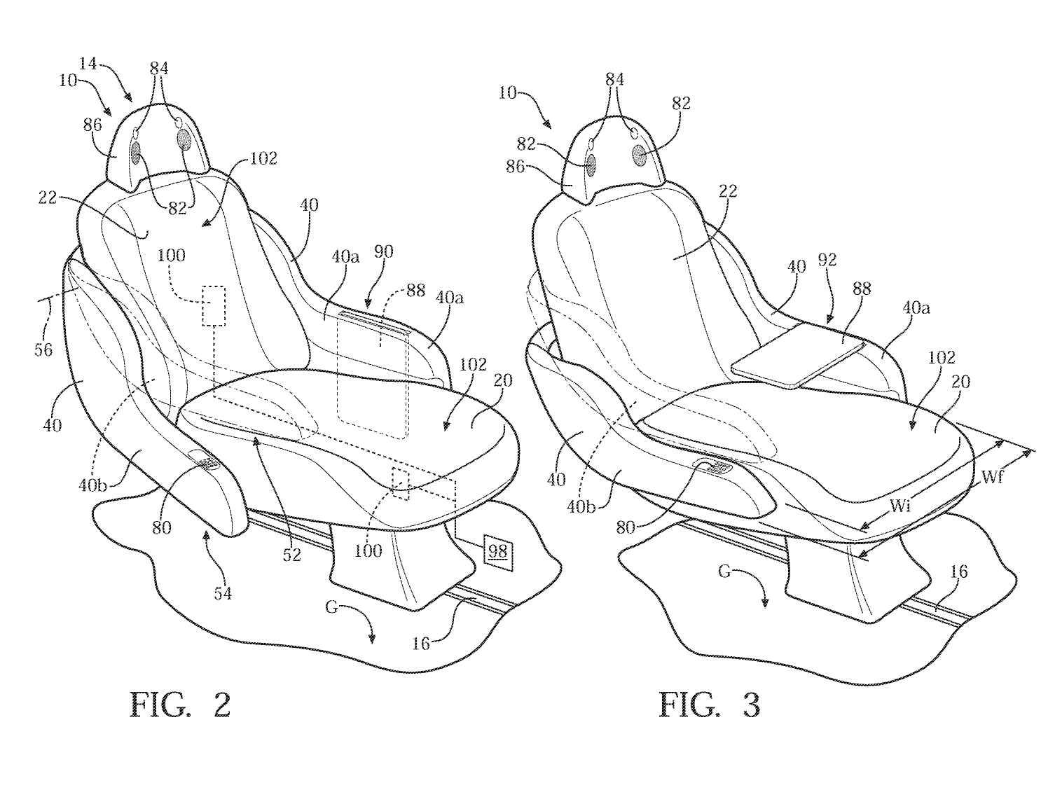

Referring now to FIGS. 2 and 3, the vehicle seat 14 may include armrests 40 for supporting arms of the user 24 of the vehicle 12. The armrests 40 may include an inboard armrest 40a and an outboard armrest 40b that extend from the seatback 22. The inboard armrest 40a is the armrest 40 that is furthest inboard in the vehicle 12 and the outboard armrest 40b is the armrest 40 that is furthest outboard in the vehicle 12. The inboard armrest 40a may allow the size of a center console 46 of the vehicle 12 to be reduced, while providing comfort to the user 24. Likewise, the outboard armrest 40b may allow armrest 40s that are typically located on a door panel of the vehicle door 30 to be eliminated. The outboard armrests 40b may be configured to move out of the user's 24 way, i.e., from a first position 52 to a second position 54. Referring specifically to the outboard armrest 40b in FIG. 2, the outboard armrest 40b may be configured to rotate toward the ground G from a generally horizontal first position 52 to a generally diagonal second position 54, about a point of rotation 56. The point of rotation 56 is located where the outboard armrest 40b is connected to the seatback 22. The first position 52 is the position of the outboard armrest 40b that supports the user's 24 arm when the user 24 is seated in the vehicle seat 14. In the second position 54, the outboard armrest 40b is moved out of the way to assist the user 24 during ingress and/or egress to the vehicle 12. Additionally, when the outboard armrest 40b is in the second position 54, the outboard armrest 40b may be used as a handle to be grasped by the user 24 to further assist during ingress and/or egress to the vehicle 12.

Referring specifically to the outboard armrest 40b in FIG. 3, the outboard armrest 40b may be configured to move vertically, relative to the ground G, from a generally horizontal first position 52 to a generally horizontal second position 54. The first position 52 is the position of the outboard armrest 40b that supports the user's 24 arm when the user 24 is seated in the vehicle seat 14. The second position 54 moves the outboard armrest 40b to be generally flush with the lower seat cushion 20, such that an initial width Wi of the lower seat cushion 20 is increased to a final width Wf in order to assist the user 24 during ingress and/or egress to the vehicle 12.

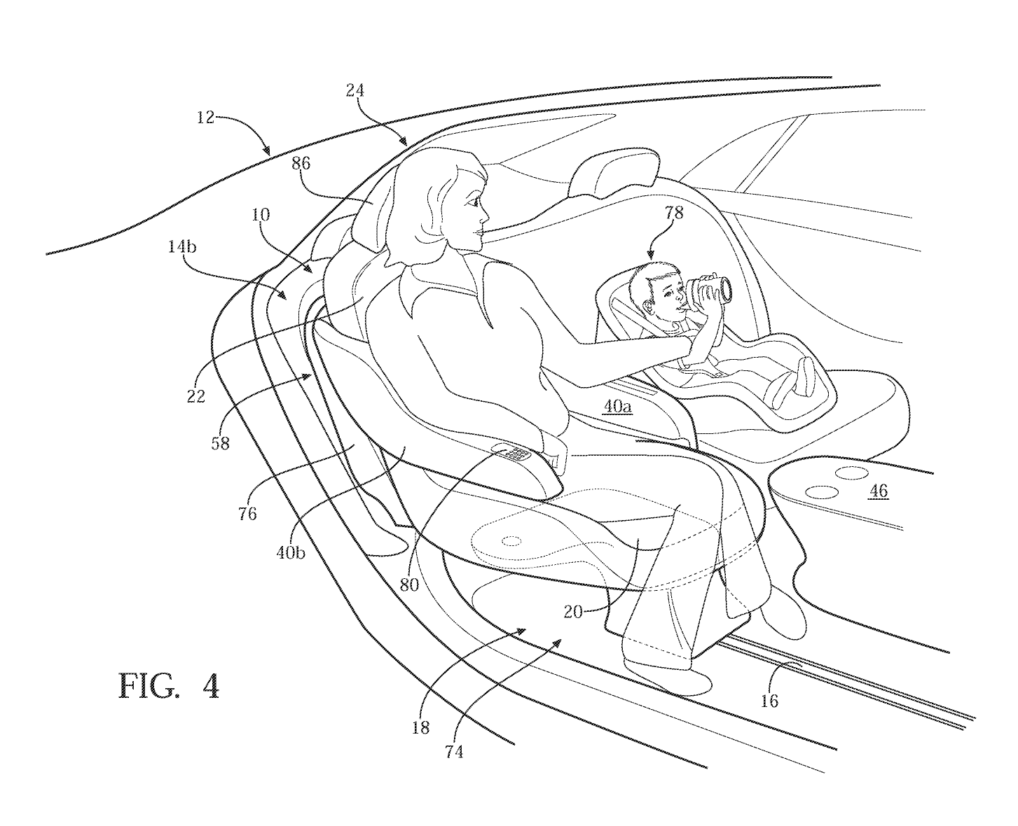

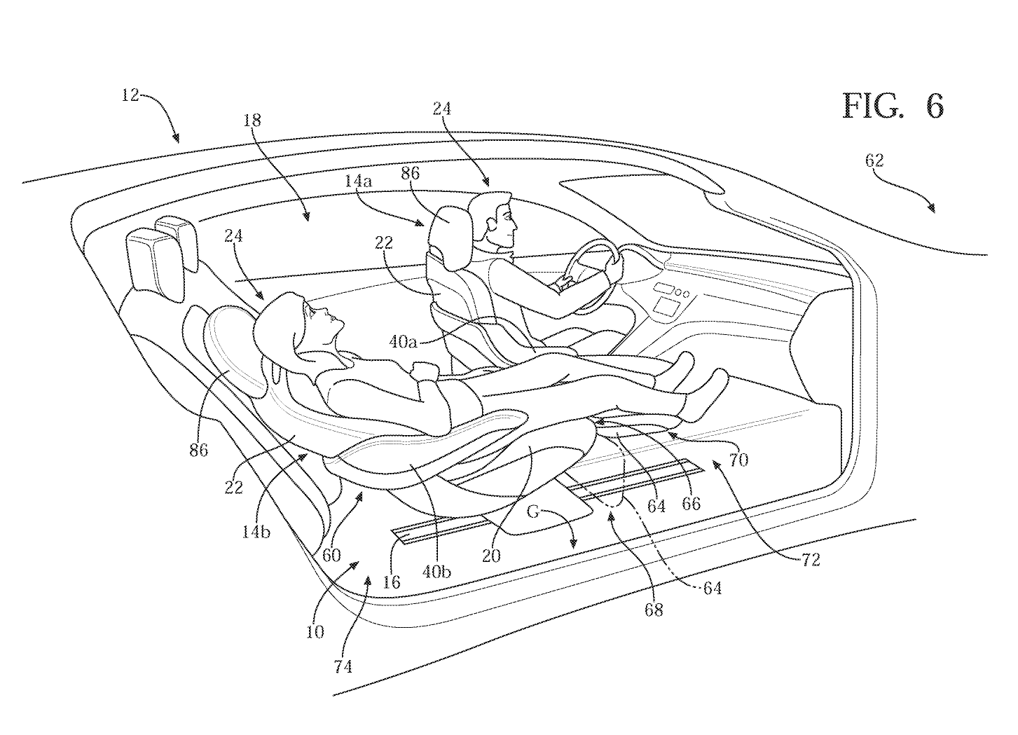

Referring to FIG. 6, the vehicle seat 14 may be configured to move to from an upright position 58 (as shown in FIG. 4) to a reclined position 60 (as shown in FIG. 6). In the reclined position 60, the seatback 22 may rotate backward, relative to a front 62 of the vehicle 12, to the reclined position 60. In addition, the vehicle seat 14 may include a foot rest 64 that operatively extends from a forward end 66 of the lower seat cushion 20. The foot rest 64 is movable between a retracted position 68 and an extended position 70. When the foot rest 64 is in the retracted position 68, the foot rest 64 is out of the way of the user's 24 legs. When the foot rest 64 is in the extended position 70, the foot rest 64 is configured for supporting lower legs of the user 24.

Referring to FIG. 4, the seat track 16 may be an extended seat track 16. The extended seat track 16 extends from a front row 72 of the vehicle 12, all the way to a rear row 74 of the vehicle 12 located behind the front row 72, generally beneath a rear vehicle seat 14. This extended seat track 16 allows the vehicle seat 14 to move from the front row 72 to the rear row 74 to attend to cargo or children 78 seated in the rear row 74 of the vehicle 12. A corresponding rear vehicle seat 14 may be configured such that a lower rear seat cushion 76 moves out of the way of the vehicle seat 14 to make room for the vehicle seat 14 when the vehicle seat 14 slides along the extended seat track 16.

Referring again to FIGS. 2 and 3, the vehicle seat 14 may provide additional functionality to the user 24. The armrest 40 may include one or more buttons 80 that are configured for operating features of the vehicle 12 that may be a radio, lighting, windows, door locks, an HVAC system, and the like. By placing one or more buttons 80 on the armrest 40, the user 24 would be able to control the corresponding feature within the vehicle 12, no matter where the vehicle seat 14 is physically located within the vehicle 12, i.e., in the front row 72 or the rear row 74, or regardless of the position of the vehicle seat 14, i.e., in the upright position 58 or the reclined position 60.

Additionally, referring to FIGS. 2 and 3, the vehicle seat 14 may include speakers 82 and/or lighting 84 integrated therein. The vehicle seat 14 may include a headrest 86 that is configured for supporting a head of the user 24 and the speakers 82 and/or lighting 84 may be integrated within the headrest 86. It should be appreciated, however, that the speakers 82 and/or lighting 84 are not limited to being integrated into the headrest 86, but may be integrated into other portions of the vehicle seat 14, as known to those skilled in the art.

Referring again to FIGS. 2 and 3, the vehicle seat 14 may include a front tray table 88 that is selectively available to the user 24. More specifically, referring to FIG. 2, the front tray table 88 may be disposed within one of the armrests 40 when not in use, i.e., a stowed position 90. When the user 24 wants to use the front tray table 88, the user 24 extracts the front tray table 88 from within the armrest 40 and moves the front tray table 88 to an in-use position 92, as shown in FIG. 3. It should be appreciated that the front tray table 88 is not limited to the type as described herein, as any other type of tray table, known to those skilled in the art may also be used.

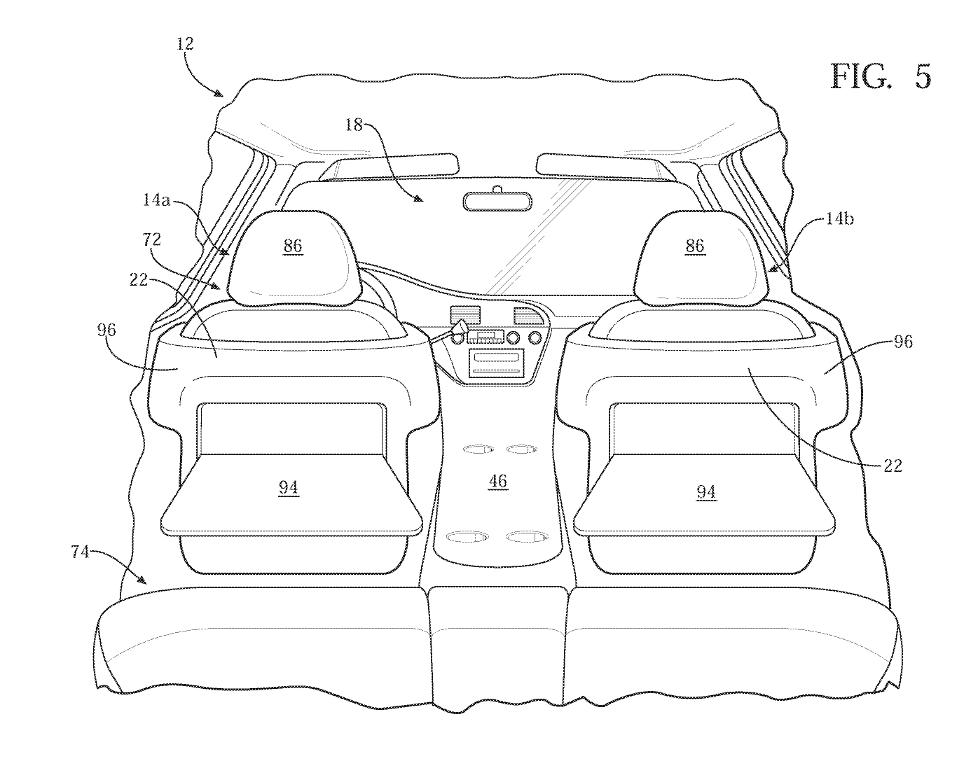

Referring to FIG. 5, a rear of the vehicle seat 14s may include a rear tray table 94 that is selectively available to the user 24. More specifically, the rear tray table 94 may be disposed within a rear 96 of the seatback 22 when not in use, i.e., in a stowed position. When the user 24 wants to use the rear tray table 94, the user 24 in the rear row 74 extracts the rear tray table 94 from within the rear 96 seatback 22 and moves the rear tray table 94 to an in-use position 92. It should be appreciated that the rear tray table 94 is not limited to the type as described herein, as any other type of tray table, known to those skilled in the art may also be used.

Additionally, referring to FIG. 2, in order to provide individualized comfort to the user 24, the vehicle seat 14 may be configured such that the seatback 22 and the lower seat cushion 20 conform to contours of individual users 24 of the vehicle seat 14. More specifically, the vehicle seat 14 may be configured to selectively conform to the contours of each user 24. For example, in one embodiment, the contours or shape of the user 24 may be preprogrammed into a controller 98 for the vehicle seat 14. One or more actuators 100 may be disposed within the vehicle seat 14. The actuators 100 may be selectively actuated to conform to surfaces 102 and underlying cushioning of the vehicle seat 14, i.e., lower seat cushion 20, seatback 22, and the like, move to conform these contours. Any number of users 24 may be preprogrammed into the controller 98 the vehicle seat 14 such that, when a selection is made, the vehicle seat 14 conforms to match the unique contours of that particular user 24. It should be appreciated that adjusting the vehicle seat 14 to match the contours of the users 24 is not limited to that as described herein, as any other method of changing the contours, as known to those skilled in the art may also be used.

While the best modes for carrying out the invention have been described in detail, those familiar with the art to which this invention relates will recognize various alternative designs and embodiments for practicing the invention within the scope of the appended claims.

1. A vehicle seat configured for use within a front of a vehicle, the vehicle seat comprising.
a lower seat cushion configured for supporting a user of the vehicle;
a seatback extending from the lower seat cushion and includes a surface configured for supporting a torso of the user of the vehicle;
wherein the lower seat cushion is pivotable about a pivot point that enables rotation of the lower seat cushion generally horizontally from an inboard position to an outboard position.

2. A vehicle seat, as set forth in claim 1, wherein the seatback and the lower seat include are pivotable about a pivot point that enables rotation of the lower seat cushion and the seatback generally horizontally from an inboard position to an outboard position.

3. A vehicle seat, as set forth in claim 1, wherein the vehicle seat includes at least one armrest configured for supporting an arm of the user of the vehicle.

4. A vehicle seat, as set forth in claim 3, wherein the at least one armrest is an inboard armrest and an outboard armrest.

5. A vehicle seat, as set forth in claim 4, wherein the outboard armrest is configured for moving from a first position to a second position.

6. A vehicle seat, as set forth in claim 5, wherein the armrest is configured for rotating relative to the seatback from the first position, that is generally horizontal, to the second position, that is generally diagonal with respect to the surface of the lower seat cushion.

7. A vehicle seat, as set forth in claim 5, wherein the armrest is configured for moving generally vertically from the first position, that is generally horizontal, to the second position, that is generally horizontal.

8. A vehicle seat, as set forth in claim 7, wherein the armrest is generally flush with the lower seat cushion when the armrest is in the second position.

9. A vehicle seat, as set forth in claim 3, wherein the at least one armrest includes at least one button configured for operating features of the vehicle.

10. A vehicle seat, as set forth in claim 3, further including a tray table configured for moving between a stowed position and an in-use position.

11. A vehicle seat, as set forth in claim 10, wherein the tray table is disposed inside the at least one armrest when the tray table is in the stowed position.

12. A vehicle seat, as set forth in claim 10, wherein the tray table is disposed inside a rear of the seatback when the tray table is in the stowed position.

13. A vehicle seat, as set forth in claim 1, wherein the seatback includes at least one of a speaker and a light.

14. A vehicle seat, as set forth in claim 1, wherein the seatback includes a headrest configured for supporting a head of the user, the headrest including at least one of a speaker and a light.

15. A vehicle seat, as set forth in claim 1, further comprising a footrest extending from a front of the lower seat cushion, the footrest movable from a retracted position to an extended position.

16. A vehicle seat, as set forth in claim 15, wherein the seatback is configured for moving from an upright position to a reclined position.

17. A seat system for a vehicle defining an interior of the vehicle having a front row and a rear row behind the front row, the seating system comprising:
an extended seat track extending within the interior of the vehicle between the front row and the rear row;
a front vehicle seat movably attached to the extended seat track;
wherein the front vehicle seat is configured to move along the extended seat track between the front row and the rear row.

18. A vehicle seat, as set forth in claim 17, further comprising a footrest extending from the front vehicle seat;
wherein the footrest is movable from a retracted position to an extended position.

19. A vehicle seat, as set forth in claim 18, wherein the front vehicle seat includes a lower seat cushion and a seatback extending from the lower seat cushion;
wherein the seatback is configured for moving from an upright position to a reclined position

20. A vehicle seat configured to provide individualized comfort to a user, the vehicle seat comprising:
a lower seat cushion having a surface configured for supporting the user;
a seatback having a surface configured for supporting a torso of the user, the seatback extending from the lower seat cushion;
a controller operatively connected to at least one of the lower seat and the seatback;
wherein the controller is configured for being preprogrammed with contours of at least one user;
wherein the controller is configured for actuating at least one of the lower seat and the seatback to selectively change a contour of the surface of the at least one of the lower seat and the seatback to match the contours of the at least one user.
